(19) United States
(12) Patent Application Publication
(10) Pub. No.: US 2004/0077382 A1
(43) Pub. Date: Apr. 22, 2004

(54) Mobile telephones

(76) Inventor: Nigel Charles Verity, Braishfield (GB)

Correspondence Address: Joseph A Sebolt, Sand & Sebolt, Aegis Tower Suite 1100, 4940 Munson Street NW, Canton, OH, 44718-3615, US

(21) Appl. No.: 10/344,808

(22) PCT Filed: Aug. 3, 2001
(86) PCT No.: PCT/GB01/03521

(30) Foreign Application Priority Data
Aug. 15, 2000 (GB) 0019910.9

(51) Int. Cl. H04M 1/00

(52) U.S. Cl. 455/569.1; 455/550.1

(57) ABSTRACT

The invention relates to improvements in and relating to mobile telephones and specifically an inexpensive and easily produced method and apparatus for the reduction of radiation exposure particularly to the head of mobile telephone users. A self-powered headset module consisting of a microphone and earphone means is connected to a mobile phone by duplex communicating means of an approximately one metre length of fibre optic cable and a special adapter which interconnects with the mobile phone itself. Signals from the microphone are modulated and sent down the fibre optic cable as series of light pulses. Similarly, the earphone signal from the mobile phone is sent up the fibre optic cable as a series of light pulse. The fibre optic cable provides a reliable, secure and interference free method of complete electrical isolation between the users head and the mobile phone. The cable may be further retractable, typically on a winding spool thus conveniently storing the cable when not in use.

The present invention relates to improvements in and relating to mobile telephones and in particular to a method and apparatus for the reduction of radiation exposure from mobile telephones.

### BACKGROUND OF THE INVENTION

Until approximately 1997 mobile telephones tended to be used only by a select, wealthy few. These were typically business people who could afford the relatively high cost of both the devices and call charges. Even these people tended to use their mobile telephones sparingly and to keep the length of their average call relatively short.

Since then the cost of mobile telephones has rapidly reduced with the cost of per minute used now down to levels which match or, in some cases, even improve upon the cost of using a conventional land line telephone. Over the same time frame their popularity and use has increased exponentially among the regular population to the point where currently, about half the population of the UK now own and regularly use mobile telephones. This includes hundreds of thousands (if not millions) of children below the age of 16 to ages as low as 5. The average length of the calls has similarly increased with many people spending more than half an hour on average on their mobile telephone each day. The cost of ownership and use are now so competitive that many people make the choice of a mobile telephone rather than a landline-based device.

However, reports of headaches, dizziness, feelings of nausea and other unpleasant symptoms from mobile phone use are becoming conmmonplace. Generally, these symptoms take about 20 minutes per call of mobile phone use to appear. However, in some cases, people report problematic symptoms after only a few minutes. Headaches seem to be concentrated behind the ear, which is being used for the mobile telephone.

In fact, the living tissue of the head and particularly the brain of the mobile telephone user are being exposed to a powerful source of modulated microwave energy for the duration of each call. The intensity of this exposure is greatly affected by the closeness of the telephone set to the user's ear. The intensity is a function of the inverse of the distance between the handset and the head squared. (For example: by moving the handset from 1 cm to 10 cm from the ear, the peak, radiation exposure of the head is reduced by 100 times.)

But it is often difficult, if not impossible, to bear clearly unless you hold the set right against your ear. For this reason, among others, manufacturers offer “hands free kits”. These generally comprise an earphone that goes in the ear for support connected by a short wire to a microphone that can clip onto the collar and from which a thicker wire extends about one meter with an adapter connector for the mobile phone on its end. The connector can be plugged into the particular model of mobile telephone required, with each one tending to be unique.

These conventional “Hands free kits” are very simple and traditional in design. The electromechanical earphone is directly driven by the mobile phone by simple direct electrically conductive means of a pair of electrical wires plugged into the mobile phone itself. Similarly a pair of electrically conductive wires directly to the mobile phone itself connects an electromechanical microphone.

In the past these “Hands free kits” were claimed in advertising in some countries to be “radiation reducing devices”. In contrast, in the UK, the cell phone industry who make most of the hands free kits or at least distribute them, have never directly claimed that the kits reduce any health risk, because they have steadfastly denied any such risk exists. The idea that kits protect was nonetheless, inferred by some distributors. However, recent studies made by consumer watchdogs in the UK claim that, in fact, rather than reducing the exposure, many of these “Hands free kits” actually “act like an aerial, directing as much as three times the microwave radiation into the brain” as a phone held next to the ear. The Consumer Association only tested the “Hands free kits” for electric field strength not Specific Absorption Rate (SAR). SAR is a measure of the radiation absorbed by the head.

An independent expert group headed by the Governments former Chief Scientific Advisor, Sir William Stewart published a report on mobile phones and health in May 2000. This is known as the Stewart Report. It argued that “properly designed kits might protect” but it is inconclusive and recommends further research. Importantly, none of these aforementioned tests as well as the test recently reported in Australia and the original tests by Niels Kuster had any biological target but are simply electronic tests comparing compliance with the present regulatory guidelines. Some scientists hotly dispute these guidelines.

Of even more concern are the findings of recent biologically based studies that exposure to this powerful mobile telephone radiation actually does have a debilitating effect on that part of cellular human immunity which has the prime responsibility for the detection and elimination of cancerous tumors. These are the lymphocyte cells. The studies duplicated precisely the conditions that occur in the head of mobile telephone users when they are making or receiving a call using either a “hands free kit” or just the mobile phone itself. Actual human lymphocyte cells were used in the studies and the results were cause for concern. In particular danger are children who, in the process of growing, are undergoing rapid cell duplication and are therefore so much more at risk Consequently, the UK government has recently sent out a warning to all UK schools to restrict young people under the age of 16 from using mobile telephones for any other than essential purposes while at school premises. (Some studies on the effects of different types of microwave radiation on DNA, Animals and human beings are listed in the references of this application).

The problem of how to reduce the level of exposure inexpensively to safe levels in users of mobile phones remains largely unsolved in the present market. Some manufacturers have introduced the idea of a wireless link between the headset and the phone to solve this problem. There are two wireless approaches. One uses low power radio signals, which requires an additional transmitter and receiver to be built into the handset as well as a relatively expensive headset that would also need its own matching transmitter and receiver to communicate with the handset. Another approach, described in Patent Number: WO9826513 (Siemans) dated Jun. 18, 1998 teaches the use of a wireless infrared link to send the earphone signal from the handset to the earphone through the air (the microphone signal is not included). The problems of both of these approaches are expense and interference. In both cases great care needs to be taken to ensure that the signal is not lost or subject to serious interference between the handset and earphone. In both cases the problems of design and the high cost of production of the technology has, up to this time, apparently prohibited their appearance in the general market place.

It is an object of the present invention to overcome at least some of the aforementioned problems or provide the public with a useful alternative.

It is a further object of the present invention to provide for a mobile phone attachment that can be produced at relatively low cost and thus be affordable to the public at large, or at the very least to be comparable in cost to hands-free sets.

### SUMMARY OF THE INVENTION

Therefore in one form of the invention there is proposed a mobile phone device including:

a first module and a second module, said first module adapted to be worn by a user, said second module adapted to be connected to a mobile phone;

said modules coupled by the use of a fibre optic cable, said cable enabling communication in the visible part of the electromagnetic spectrum between the two modules;

said first module including a microphone and a loudspeaker and further including appropriate first translation circuitry to convert an electric signal into a light signal and vice versa;

said second module including second translation circuitry to convert an electric signal into a light signal and vice versa;

wherein in use, the signal from the mobile phone to the loudspeaker is converted by the second module into a light signal, said signal transmitted through the fibre optic cable to be received by the first module where the first translation circuitry converts it into an electrical signal to drive the loudspeaker, and wherein the signal received by the microphone is converted by the first translation circuitry into a light signal that is transmitted through the fibre optic cable to the second module where the second translation circuitry converts it into an electrical signal that is then fed into the mobile telephone.

Preferably said first module includes its own power supply.

In a further form of the invention there is proposed a mobile telephone device for reducing radiation exposure to a users head including:

a first module having a power supply, earphone, microphone, first electronic translation circuitry to translate a received light signal into a first electrical signal to drive the earphone and second electronic translation circuitry to translate a second electric signal from the microphone into a transmitted light signal;

a second module having third electronic translation circuitry to translate the microphone transmitted light signal received from the first module into a third electric signal to be input to said mobile telephone, said second module further having fourth electronic translation circuitry to translate an electric signal from the mobile telephone into a light signal to be transmitted to the first module;

a fibre optic cable means for optically connecting said first module to said second module together to provide a fixed and secure communicating path for the received and transmitted light signals;

wherein said second module is adapted to be connected to the mobile telephone.

Preferably said device further includes a connecting adapter means for connecting the second module to the mobile telephone.

Preferably said second module includes is own power supply.

Preferably said second module is provided power from said mobile telephone.

Preferably said second module is connected to the mobile phone using an electrical adapter.

Preferably said electrical adaptor includes a connecting cable in between the mobile phone and the second module.

Preferably said first module power supply is a battery.

Alternatively the power supply is a solar cell.

Preferably said second module further includes a fibre optic storage means for storing said fibre optic device when said mobile phone is not in use.

Preferably said storage means includes a rotating drum onto which may be wound said fibre optic cable.

Preferably said drum includes a biased driving means to assist in automatically retracting or spooling said fibre optic cable onto the drum.

Preferably said drum is housed within said second module.

Preferably said second module is adapted to store said first nodule.

Preferably said second module stores said first module in an internal pocket.

Preferably said first module includes a warning device to alert the user when the power supply is below a pre-determined level.

Preferably said warning device is an audible buzzer.

Preferably said first module includes a switch for turning said first module on or off.

Preferably said first module switch is an automatic switch adapted to respond to a light signal from said second module.

Preferably said first module switch switches the first module off when said light signal from said second module is interrupted.

In preference said second module is adapted to turn on automatically when it receives a light signal from the first module.

In preference said second module is adapted to turn on automatically when it receives a signal from the mobile telephone.

Preferably said fibre optic cable is approximately one metre long.

Preferably said fibre optic cable includes a pair of fibre optic cable light carrying cores made of a suitable light transmitting material including but not limited to acrylic plastics, said pair of cables sheathed together to form a single assembly in a duplex arrangement.

Preferably said second module is adapted to be clipped to a belt of the mobile telephone.

Preferably said first module is a headset adapted to be worn by the user.

The skilled addressee will now understand that the first module which is self powered by its own battery includes an earphone and microphone and is connected to and communicates with the mobile telephone by means of approximately one metre of plastic fibre optic cable and a second module. The second module is connected to the mobile telephone by an adapter connector means. This is either a direct electrical plug connection or a short length of adapter wire cable that can be used to adapt the device to any particular model of mobile phone by means of a variety of suitable adapter connectors.

The first module is worn on the head as with conventional “hand free sets” and/or clipped to the collar by means of a suitable clip. It is totally electrically isolated from the mobile phone by means of the approximately one metre long length of fibre optic cable. This communicating fibre optic cable will conduct light signals but is entirely transparent to the microwave energy being transmitted by the mobile phone. There is no radiation-conducting path or any sort of other electrically conductive path provided by the present invention between the mobile phone and the first module for the microwave energy to travel up. This is in direct contrast to the conventional “hands free sets” currently in wide spread use. They work by means of conventional conductive wires, which provide a direct electrical connection between the mobile phone and the microphone and earphone and thus any easy path for conducting the intense microwave energy from the mobile phone directly to the head and most particularly into the delicate brain tissue behind the ear.

The first module receives the earphone modulated light signal from the second module by means of the fibre optic cable. It translates this modulated light signal into an electronic analog signal that is then boosted and used to drive the earphone. The earphone forms part of the first module or is connected to it by means of a short length of conventional two conductor cable. The electronic signal from the microphone is conditioned to achieve a required frequency and dynamic response and then modulated into a signal suitable for transmission along the fibre optic cable.

The second module connects to the mobile phone with a direct conventional electrical connection. It translates the electronic earphone signal it receives from the mobile telephone into a modulated light signal suitable for transmission up the fire optic cable to the first module. It translates the modulated microphone light signal received from the first module by means of the fibre optic cable into an analog electronic signal suitable for the mobile phone. The second module may include a battery to provide the necessary power if it is not readily available from the mobile phone connection.

The second module forms part of (by means of a direct connecting plug) and/or is situated close to the mobile phone. The most benefit can be derived from the present invention if the second module and the mobile phone are placed away from the user on a table or some other suitable surface. The benefits of even a short distance of separation are large due to the fact that the intensity of radiation is proportional to the inverse of the distance squared. (This being the distance between the exposed part of the body and the mobile phone). However, the tissues of the brain are widely held to be the most vulnerable so that using the present invention while holding the mobile phone away from the body in your hand, preferably at arms length, will greatly reduce this exposure.

The fibre optic cable has a great advantage over wireless means in that the signals passed along it are, by definition, completely private and isolated from all forms of electronic interference. This is in direct contrast with wireless means all of which suffer from the problems of interference. The interference from which wireless means are vulnerable can come from many sources. One mechanism is the potential problem of interference from fellow users. If a number of mobile phone users were to make or receive calls while in close proximity to each other then there could be a very real possibility of these low power wireless transmissions being intercepted by the wrong head set. Additionally, modulated light signal can be efficiently sent along fibre optic cables using very low power, much lower than that required sending such signals by wireless infrared means. This is of particular concern in the present invention that seeks to provide two-way isolation. Signals need to be sent both down from the first module for the microphone as well as received up for the earphone. It is not practical to use the relatively large and cumbersome batteries required in a light headset. Battery life is also of prime concern: very small and light batteries must provide extensive life.

### DESCRIPTION OF THE PREFERRED EMBODIMENTS

The accompanying drawings, which are incorporated in and constitute a part of this specification, illustrate an implementation of the invention and, together with the description, serve to explain the advantages and principles of the invention. In the drawings,

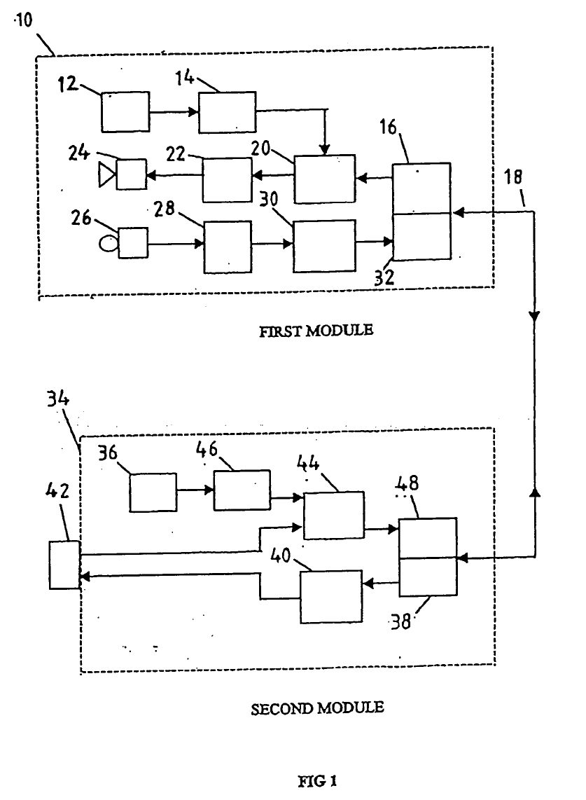

FIG. 1 is a block diagram illustrating the operation of a mobile phone improvement according to the present invention;

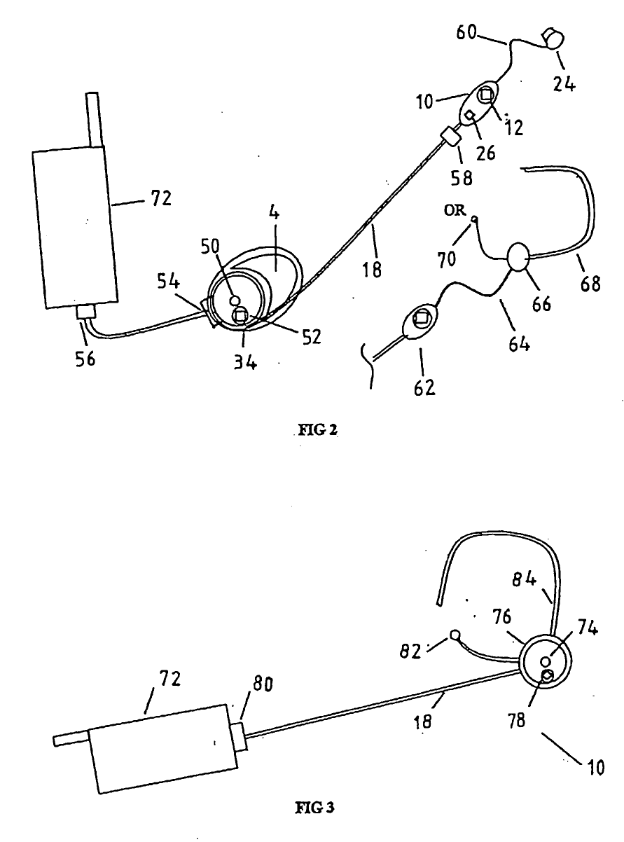

FIG. 2 is a schematic perspective view of a first embodiment of a mobile phone improvement embodying the present invention, said improvement having a clip-one microphone;

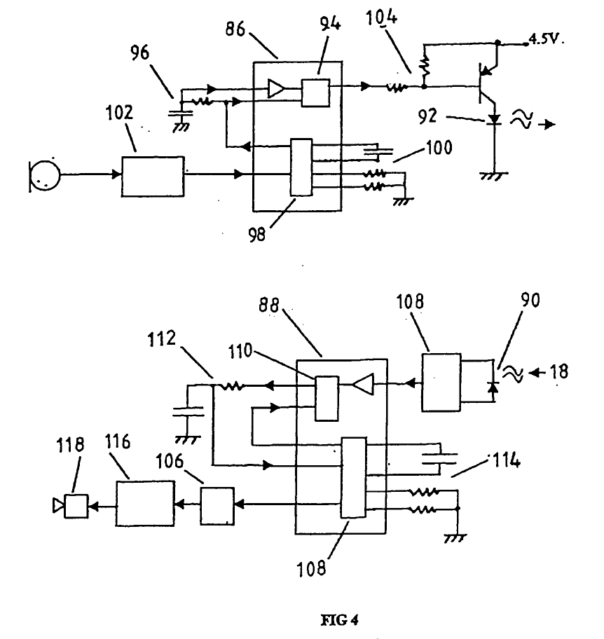

FIG. 3 is a schematic perspective view of a second embodiment of a mobile phone improvement embodying the present invention, said improvement including a head-seat microphone and earpiece;

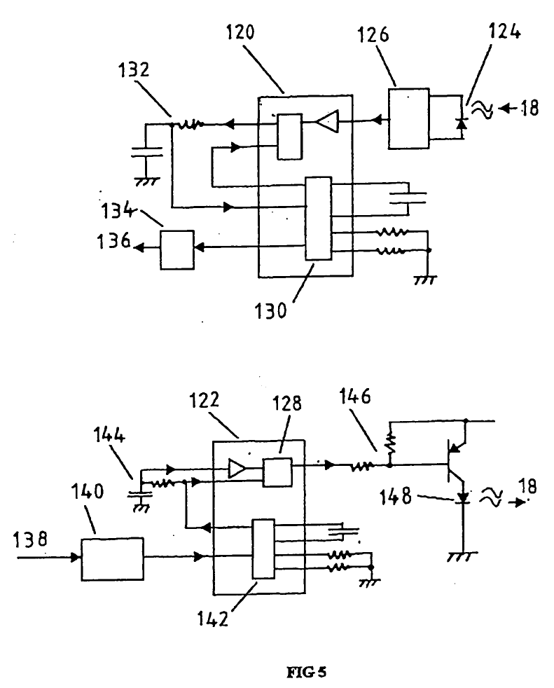

FIG. 4 is a circuit diagram illustrating the electronic operation of the mobile phone attachment first module according to the present invention; and

FIG. 5 is a circuit diagram illustrating the electronic operation of the mobile phone attachment second module according to the present invention.

### DESCRIPTION OF THE PREFERRED EMBODIMENT

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

Referring now to FIG. 1, there is shown a first module 10 including a battery 12 is an electrical power source, a low battery voltage detector 14, a light receiver 16 which receives a modulated light signal from the fibre optic cable 18, an earphone signal demodulation translator 20 which translates this modulated signal into an analog electronic signal, an earphone driver circuit 22, an earphone 24, a microphone 26, a microphone signal electronic preconditioner 28, a microphone analog signal translator 30 which translates the signal into a modulated form suitable for light transmission and a light transmitter 32 connected to the fibre optic cable 18.

The second module 34 in FIG. 1 comprises a battery as an electrical power source 36 (if power is not readily available from the mobile phone “hands free set” plug in connection), a light receiver 38 which receives a modulated light signal from the fibre optic cable 18, a microphone light signal translator 40 which translates the modulated signal into an analog electronic signal, a conventional conductive connector adapter 42 which electrically connects the second module to the mobile phone, an earphone analog signal translator 44 which translates the analog earphone signal received from the mobile phone into a modulated form suitable for light transmission, a low battery detector 46, and a light transmitter means 48 connected to the fibre optic cable 18.

FIG. 2 shows a preferred embodiment wherein the second module 34 consists of a fibre optic reel storage and supply mechanism with an automatic retracting button 50 in a plastic housing which also includes the second modules complete electronic circuit board, battery 52, a pouch for convenient storage of the first module 8 when not in use, an adapter connector means 54 & 56, a fibre optic cable means 18, a collar clip 58 to secure the first module 10 and/or fibre optic cable 18 to the collar, a plastic casing to house the electric circuit board of the first module 10, a microphone 26, a battery 12, and earphone 24 for use inside the ear, a short length of two conductor interconnecting cable for the “in the ear” earphone 60. Alternatively, for the case of a earphone and microphone supported by a clip over the ear a plastic case 62 housing the electronic circuit board and battery an interconnecting three or four conductor conventional cable 64, an earphone 66, an over the car clip 68, a microphone 70 and a mobile phone 72.

FIG. 3 illustrates a preferred embodiment wherein the first module 10 consists of a fibre optic reel storage and supply mechanism with an automatic retracting button 74 in a plastic housing 76 which also includes the first modules complete electronic circuit board, earphone and battery 78, an adapter connector means which houses the entire second module 80, a fibre optic cable means 18, a microphone boom 82, a head clip 84 for holding the first module in place and a mobile phone 72.

In the preferred embodiment inexpensive mechanical fibre optic and electronic parts are used and combined in a novel and highly cost effective way to produce a complete assembly which is, even though considerably more complex that the conventional wire connected “hands free sets” currently in widespread use, still competitive in the market place at a similar price well within the financial reach of every concerned user. Battery size and battery life is of prime concern. In order to receive wide acceptance the whole assembly of the present invention must conveniently fit in the users pocket, preferably without the problem of becoming tangled in such a way as to be difficult to use the next time it is required. The fibre optic cable must be robust but easy to store away. This is the purpose of the windup mechanism for the fibre optic cable as described herein above and depicted in FIGS. 2 and 3.

The fibre optic cable may be single or a two core pair sheathed in a light blocking and protective material. In a preferred embodiment the core material is acrylic plastic and the sheath is also a plastic material. In the case of the single fibre, lenses are required at each end to separate the sent and received light signals for transmission and detection. This can be expensive. In the preferred embodiment a two core pair is used and the modulation and demodulation of the light signals is be done in a very efficient and novel way using four micro-power phase-lock-loop circuits: a pair for modulation and demodulation in each module.

FIG. 4 shows the circuit diagram of the modulation 86 and demodulation 88 scheme of the first module in a preferred embodiment. Two CMOS “4000 logic series” micro-power analog Phase-Lock-Loop (PLL) incorporated microcircuit “chips” are used in a novel way. One 86 to modulate the microphone analog audio signal into a series of approximately 2.5 microsecond pulses which can be used to drive intense light pulses down the communicating fibre optic cable 18 and another 88 to demodulate a similar series of approximately 2.5 microsecond pulses received from the fibre optic cable 18 for the earphone.

A Pin diode 90 is used as a transducer to translate the received earphone light pulses into electrical signals suitable for demodulation. A fast and efficient Light Emitting Diode (LED) 92 is used to translate the electrical signal output by the modulator 86 into light signals. One object of the invention is to keep power consumption and cost to a minimum. The use of the PLL's achieves this in a novel way. The Phase sensitive detector 94 of the microphone modulator is used by means of a phase shifter 96 (consisting of only one capacitor and one resistor) to produce approximately 2.5 microsecond pulses with no other external components required.

Three 1.5 Volt alkaline “button cell” batteries are combined to provide the power source of 4.5 Volts. The current consumption of the microphone signal modulator is only approximately 80 micro amps. A direct voltage to frequency conversion 98 is provided by the modulator wherein the microphone signal is translated into a series of 2.5 uS pulses whose frequency varies in the range from 30 kHz to 60 kHz. Two resistors and one capacitor 100 are used to set this range. Of major importance is this novel yet elegantly simple method for reducing the power consumption by making the light pulses as short as practically possible to reduce the duty cycle of LED “on time” versus “off time”. At 60 KHz this duty cycle is 2.5/16.666=15% whereas at 30 kHz the duty cycle is 7.5%. Thus battery life is increased sufficiently enough to make the invention practical for the market.

The microphone signal is preconditioned 102 before being used to drive the voltage to frequency converter 98. Inverting circuitry 104 is used to drive the LED 92. A high frequency is chosen to provide good audio quality and make filtering of the demodulated signal 106 as simple and inexpensive as possible. A preamplifier 108 prepares the received earphone signal modulated pulses for detection by the Earphone PLL 88. The voltage-controlled oscillator 108 receives the output of the phase sensitive detector 110 that has been averaged by the resistor capacitor combination 112. The frequency detection range is set to match the transmitted signal by two resistors and one capacitor 114. Thus the demodulator PLL locks its synthesized frequency to that of the incoming earphone light pulse signal. The demodulated earphone signal is then filtered 106 and used for the earphone driver 116 to drive the earphone 118. In order to keep the size of the assembly as small as possible for the convenience of the user “chip on board” assembly techniques are used. This means that the bare silicon PLL chips are bonded directly to the printed circuit board and wired up in place as compared with using the conventional plastic encapsulated incorporated circuits (ICs).

FIG. 5 shows the circuit diagram of the demodulation 120 and modulation 122 scheme of the second module in a preferred embodiment. Two CMOS “4000 logic series” micro-power analog PLLs are used in just the same way as in the first module. One PLL demodulates the microwave light pulse signal received from the communicating fibre optic cable 18 by means of a pin diode 124 and a preconditioner 126. The phase sensitive detector 128 is used to detect the frequency of the incoming signal in conjunction with the voltage-controlled oscillator 130 and the averaging circuit 132. A filtering and driving circuit 134 prepares the signal for sending to the mobile phone microphone connection 136. Likewise, the earphone signal received from the mobile phone 138 is buffered 140 and used to drive the voltage to frequency converter 142 to derive a frequency in the range of 30 kHz to 60 kHz, which is changed into a series of 2.5 uS pulses by means of a phase shifter 144 and phase sensitive detector 128. The modulator 122 then drives light pulses into the fibre optic cable 18 by means of the inverter-driver 146 and LED 148.

Another arrangement could be to use a single fibre with a “ping pong” scheme to sequentially send the modulated signal first in one direction for the microphone and then in the other for the earphone. However, this is considered to be a more expensive and therefore less desirable solution as it would tend to put the invention out of reach financially speaking for many members of the general public.

Test Results of the Present Invention

The preferred embodiment of the invention as described herein above has been constructed and tested using a “double blind” test to compare the radiation exposure effect on human lymphocyte cells of the invention as against a conventional “hands free kit”. A test of eight hours duration was performed using a Nokia mobile telephone handset. The test was carried out by Coghill Research Laboratories between 11^{th} and 13^{th} Aug. 2000.

The latest Government “SAR report” published on 8^{th} Aug. 2000 as widely reported in the national press “gives the (conventional hands free kits) earphones the all clear” saying they “limit exposure to potentially dangerous radiation”. This leads to the expectation that results of this 13^{th} Aug. 2000, Coghill Research Laboratories test should show the present invention to be approximately the same and not much better than the conventional “hands free kit”. Unexpectedly, the present invention showed Radiation Exposure results that are very much better than the conventional “hands free kit”. The preliminary report states “The device (the present invention) appears to offer good protection compared with controls”.

Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

### References

A. Prior Art (Patent Search Results)

Patent Number: WO09826513 Jun. 18, 1998 Seimans A G et al

B. Scientific Studies:

1. S. Szmigielski, A Szudzinski et al: Acceleration of cancer development in mice by long-term exposition to 2450 mHz (CW) microwave fields in Ondes Electromagnetiques and Biologie, A. J. Bertraud & B. Servantie, eds URSI Paris 165-169 (1980)

2. S. Szmigielski: Immunological response of mammals to microwaves. In Biomedical thermology, C Alberts & M. Gauthrie ads Alan R. Liss, New York 227-246 (1982)

3. D. B. Lyle, P. Schecter, et al: Suppression of T-Lymphocyte Cytotoxicity following exposure to Sinusoidally Amplitude Modulated RF fields Bioelectromagnetics, 4:281-292 (1983)

4. Shano-Binjie Chiang-Huaj & Xing-Hua Wang: Experimental Research in China on the Biological Effects of Microwaves: J. Bioelectricity J. 4:103-130 (1985)

5. Henry Lai: Neurological Effects of Low-Level Microwave Irradiation. Abstracts: BEMS 12^{th} Ann mtg., San Antonio, Tex. (1990)

6. H. Lai & M. A. Canno et al: Nalrexone Pretreatment Blocks Microwave-Induced Changes in Central Cholinergic Receptors: BEMS. 12:27-33 (1991)

7. Henry Lai et al: Effects of Acute and Repeated Microwave Exposures on Benzodiazepine Receptors in the Brain of Rat Abstracts: BEMS 12^{th} Ann Mtg San Antonio, Tex.

8. Henry Lai: Research on the Neurological Effects of Non-ionizing Radiation at the University of Washington Bioelectromagnetics J.13:513-526 (1992)

9. H. Lai & Narendra Singh: Acute Low Intensity Microwave Exposure Increases DNA Single Strand Breaks in Rat Brain Cells: BEMS J. 16:207-210 (1995)

10. S. Szmigielski: Updated study of Polish Airforce personnel exposure to high frequency EM radiation reported in Microwave News, May/June 1995 and Science of the Total Environment.

1. A mobile phone device including:
a first module and a second module, said first module adapted to be work by a user, said second module adapted to be connected to a mobile phone;
said modules coupled by the use of a fibre optic cable, said cable enabling communication in the visible part of the electromagnetic spectrum between the two modules;
said first module including a microphone and a loudspeaker and further including appropriate first translation circuitry to convert an electric signal into a light signal and vice versa;
said second module including second translation circuitry to convert an electric signal into a light signal and vice versa;
wherein in use, the signal from the mobile phone to the loudspeaker is converted by the second module into a light signal, said signal transmitted through the fibre optic cable to be received by the first module where the first translation circuitry converts it into an electrical signal to drive the loudspeaker, and wherein the signal received by the microphone is converted by the first translation circuitry into a light signal that is transmitted through the fibre optic cable to the second module where the second translation circuitry converts it into an electrical signal that is then fed into the mobile telephone.

2. A mobile telephone device as in claim 1 wherein said first module includes its own power supply

3. A mobile telephone device for reducing radiation exposure to a users head including:
a first module having a power supply, earphone, microphone, first electronic translation circuitry to translate a received light signal into a first electrical signal to drive the earphone and second electronic translation circuitry to translate a second electric signal from the microphone into a transmitted light signal;
a second module having third electronic translation circuitry to translate the microphone transmitted light signal received from the first module into a third electric signal to be input to said mobile telephone, said second module further having fourth electronic translation circuitry to translate an electric signal from the mobile telephone into a light signal to be transmitted to the first module;
a fibre optic means for optically connecting said first module to said second module together to provide a fixed and secure communicating path for the received and transmitted light signals;
wherein said second module is adapted to be connected to the mobile telephone.

4. A mobile telephone device as in any one of the above claims further including a connecting adapter means for connecting the second module to the mobile telephone.

5. A mobile telephone device as in any one of the above claims wherein said second module includes is own power supply.

6. A mobile telephone device as in any one of the above claims wherein said second module is provided power from said mobile telephone.

7. A mobile telephone device as in any one of the above claims wherein said second module is connected to the mobile phone using an electrical adaptor.

8. A mobile telephone device as in claim 7 wherein said electrical adaptor includes a connecting cable in between the mobile phone and the second module.

9. A mobile telephone device as in any one of claims 2 to 8 wherein said first module power supply is a battery.

10. A mobile telephone device as in any one of claim 2 to 8 wherein the power supply is a solar cell.

11. A mobile telephone device as in any one of the above claims wherein said second module further includes a fibre optic storage means for storing said fibre optic device when said mobile phone is not in use.

12. A mobile telephone device as in claim 11 wherein said storage means includes a rotating drum onto which may be wound said fibre optic cable.

13. A mobile telephone device as in claim 12 wherein said drum includes a biased driving means to assist in automatically retracting or spooling said fibre optic cable onto the drum.

14. A mobile telephone device as in claim 12 or claim 13 wherein said drum is housed within said second module.

15. A mobile telephone device as in any one of the above claims wherein said second module is adapted to store said first module.

16. A mobile telephone device as in claim 15 wherein said second module stores said first module in an internal pocket.

17. A mobile telephone device as in any one of the above claims wherein said first module includes a warming device to alert the user when the power supply is below a pre-determined level.

18. A mobile telephone device as in claim 17 wherein said warning device is an audible buzzer.

19. A mobile telephone device as in any one of the above claims wherein said first module includes a switch for turning said first module on or off.

20. A mobile telephone device as in claim 19 wherein said first module switch is an automatic switch adapted to respond to a light signal from said second module.

21. A mobile telephone device as in claim 20 wherein said first module switch switches the first module off when said light signal from said second module is interrupted.

22. A mobile telephone device in any one of the above claims wherein said second module is adapted to turn on automatically when it receives a light signal from the first module.

23. A mobile telephone device as in any one of the above claims wherein said second module is adapted to turn on automatically when it receives a signal from the mobile telephone.

24. A mobile telephone device as in any one of the above claims wherein said fibre optic cable is approximately one metre long.

25. A mobile telephone device as in any one of the above claims wherein said fibre optic cable includes a pair of fibre optic cable light carrying cores made of a suitable light transmitting material including but not limited to acrylic plastics, said pair of cables sheathed together to form a single assembly in a duplex arrangement.

26. A mobile telephone device as in any one of the above claims wherein said second module is adapted to be clipped to a belt of the mobile telephone.

27. A mobile telephone device as in any one of the above claims wherein said first module is a headset adapted to be worn by the user.

28. A mobile telephone device as described in the above specification.

29. A mobile telephone device as described in the above specification and with reference to FIGS. 1, 2, 4 and 5.

30. A mobile telephone device as described in the above specification and with reference to FIGS. 1, 3, 4 and 5.
